(19) United States
(12) Patent Application Publication
(10) Pub. No.: US 2020/0198227 A1
(43) Pub. Date: Jun. 25, 2020

(54) STRUCTURES MADE VIA ADDITIVE MANUFACTURING HAVING MULTIPLE LOAD PATHS

(71) Applicant: The Boeing Company, Chicago, IL (US)

(72) Inventor: Jens Bold, Munich (DE)

(21) Appl. No.: 16/229,162

(22) Filed: Dec. 21, 2018

(51) Int. Cl. B29C 64/141; B64F 5/10; B64C 1/06

(52) U.S. Cl. CPC B29C 64/141; B33Y 10/00; B64C 1/064; B64F 5/10

(57) ABSTRACT

A structure and corresponding method of manufacturing are described, where the structure is fabricated via additive manufacturing. The structure includes a plurality of sub-structures integrally formed via additive manufacturing. The plurality of sub-structures provides the structure with at least three load paths in an instance in which a load is applied to the structure and is thus capable of continuing to support the load following failure of one of the sub-structures. In some cases, at least one sub-structure is designed to arrest propagation of a material failure of the structure resulting from the load.

### TECHNOLOGICAL FIELD

Components, structures, and methods are described that incorporate multiple load paths for providing enhanced load capacity. In particular, additive manufacturing solutions are described for making structures with multiple load paths.

### BACKGROUND

Additive manufacturing refers to the process of making an object by depositing material one layer at a time. Commonly referred to as 3D printing, additive manufacturing can be accomplished in several ways, from vat polymerization to Directed Energy Deposition (DED) and others.

Additive manufacturing is becoming increasingly attractive for making a wide variety of components due to the relative ease with which objects with complex shapes can be made. With additive manufacturing, computer aided design (CAD) software can be used to make a design, which is then translated into a layer-by-layer framework for an additive manufacturing machine to follow in building the object, one layer upon the next. Moreover, with additive manufacturing, various types of materials, including polymers, metals, ceramics, foams, gels, and even biomaterials may be used to build structures.

In the aerospace industry especially, there is increasing interest in using additive manufacturing to make components due to the advantages it offers over traditional manufacturing processes, which can represent a significant savings in cost and time. There remains, however, a number of significant obstacles.

### BRIEF SUMMARY

Embodiments of the invention described herein aim to address the problems identified by the inventors with respect to conventional components made via additive manufacturing processes. In particular, embodiments of the present invention may be suitable for manufacturing improved primary and secondary structures that are designed to bear high loads, such as shafts, struts, panels, etc. These structures can be either one-dimensional (e.g., rods), two-dimensional (e.g., panels), or 3-dimensional (e.g., brackets).

Accordingly, embodiments of the present invention provide for a structure fabricated via additive manufacturing, wherein the structure comprises a plurality of sub-structures integrally formed via additive manufacturing. The plurality of sub-structures is configured to provide the structure with at least three load paths in an instance in which a load is applied to the structure, and the structure is capable of continuing to support the load following failure of one of the sub-structures.

In some cases, at least one sub-structure is configured to arrest propagation of a material failure of the structure resulting from the load. In some embodiments, adjacent sub-structures may be separated by a material having different load-bearing properties than a material of the sub-structures. In other embodiments, adjacent sub-structures may be separated by an absence of material. At least one of the sub-structures may comprise a region of increased thickness. In other embodiments, adjacent sub-structures may be separated by an area of reduced stiffness.

In some embodiments, the structure may be a panel. At least one of the sub-structures may, in some embodiments, comprise a stringer extending substantially perpendicularly from a planar surface of the structure. In some cases, at least one of the sub-structures may comprise a flange extending substantially perpendicularly from a planar surface of the structure.

In other embodiments, the structure may be a tube. The plurality of sub-structures may form a plurality of triangular reinforcements or reinforcements in other, similar shapes (e.g., polygonal shapes).

In still other embodiments, a method of manufacturing a structure using additive manufacturing is provided, where the method comprises selectively providing a plurality of layers of material that combine to form a structure. At least portions of the plurality of layers integrally form a plurality of sub-structures of the structure, and the plurality of sub-structures is configured to provide the structure with at least three load paths in an instance in which a load is applied to the structure.

In some cases, at least one sub-structure may be configured to arrest propagation of a material failure of the structure resulting from the load. The structure may be capable of continuing to support the load following failure of one of the sub-structures. Forming the structure may, in some cases, comprise varying a material of at least a portion of at least one of the plurality of layers such that adjacent sub-structures are separated by a material having different load-bearing properties than a material of the sub-structures.

In some cases, forming the structure comprises selectively providing the plurality of layers of material such that adjacent sub-structures are separated by an absence of material. In some embodiments, forming the structure may comprise selectively providing the plurality of layers of material such that each sub-structure comprises a region of increased thickness.

The structure may, in some embodiments, be a panel, and forming the structure may comprise selectively providing the plurality of layers of material such that at least one sub-structure comprises a stringer extending substantially perpendicularly from a planar surface of the structure. In some embodiments in which the structure is a panel, and forming the structure may comprise selectively providing the plurality of layers of material such that at least one of the sub-structures comprises a flange extending substantially perpendicularly from a planar surface of the structure.

In other embodiments, forming the structure may comprise selectively providing the plurality of layers of material such that the structure is a tube, and forming the structure may comprise selectively providing the plurality of layers of material such that the plurality of sub-structures form a plurality of triangular reinforcements or reinforcements in other, similar shapes (e.g., polygonal shapes).

### BRIEF DESCRIPTION OF THE DRAWINGS

Having thus described example embodiments of the disclosure in general terms, reference will now be made to the accompanying drawings, which are not necessarily drawn to scale, and wherein:

FIG. 1A is a side view of a single load path structure and a dual load path structure made using additive manufacturing;

FIG. 1B illustrates the stress concentration in the single load path structure and the dual load path structure of FIG. 1A in response to application of a limit load;

FIG. 2A is a side view of a structure having three load paths that is made using additive manufacturing, where the structure includes a plurality of sub-structures in accordance with an example embodiment of the present disclosure;

FIG. 2B illustrates the stress concentration in the structure having three load paths of FIG. 2A in response to application of a limit load after failure has occurred;

FIG. 2C illustrates the stress concentration in the structure having three load paths of FIGS. 2A and 2B in response to application of an ultimate load;

FIG. 3A is a perspective view of a panel made using additive manufacturing and including extended stringers and flanges as sub-structures to provide alternative load paths in accordance with an example embodiment of the present disclosure;

FIG. 3B is a side view of the panel of FIG. 3A in accordance with an example embodiment of the present disclosure;

FIG. 4 illustrates the stress concentration in the panel made using additive manufacturing of FIGS. 3A and 3B as compared to the stress concentration of a panel with separately formed and attached stringers in response to application of an ultimate load;

FIG. 5 illustrates the stress concentration in the panel made using additive manufacturing of FIGS. 3A and 3B as compared to the stress concentration of a panel with separately formed and attached stringers in response to application of a limit load after failure had occurred; and

FIGS. 6-8 show perspective views of a tube made using additive manufacturing and including sub-structures forming triangular reinforcements in accordance with examples of the present disclosure.

### DETAILED DESCRIPTION

Some example embodiments of the present disclosure will now be described more fully hereinafter with reference to the accompanying drawings, in which some, but not all embodiments of the disclosure are shown. Indeed, various embodiments of the disclosure may be embodied in many different forms and should not be construed as limited to the embodiments set forth herein; rather, these example embodiments are provided so that this disclosure will be thorough and complete and will fully convey the scope of the disclosure to those skilled in the art. Like reference numerals refer to like elements throughout.

As noted above, additive manufacturing offers a number of advantages over traditional manufacturing techniques. For example, additive manufacturing allows for objects to go from design to product much more quickly than traditional methods, which can require several intermediate steps that are unnecessary with additive manufacturing. Moreover, because objects are built one layer at a time, additive manufacturing can be used to make objects with a much more complex geometry than traditional methods. In addition, additive manufacturing can allow for parts to be made that are lighter in weight, which can be very important in aeronautics, aerospace, and automotive applications. Also, components produced via additive manufacturing can be made using different materials for each layer to impart the desired material and physical properties.

At the same time, there are certain disadvantages to components made via additive manufacturing. With respect to metal parts, for example, components made via additive manufacturing tend to be more susceptible to fatigue cracks and catastrophic failure as compared to their counterparts made via traditional metal casting or machining processes. This is because in most metals there are grain structures that stop or inhibit crack growth. When additive manufacturing processes are used to make metal components, such natural grains are not helpful, and the resulting component is weak as compared to its forged counterpart.

Through applied skill and ingenuity, the inventor has devised improved structures and methods for making structures using additive manufacturing processes such that multiple load paths are provided within the structures, thereby allowing the resulting components to have a higher load-bearing capacity and to sustain some damage due to fatigue without allowing the damage to propagate and/or compromise the load-bearing capacity of the component.

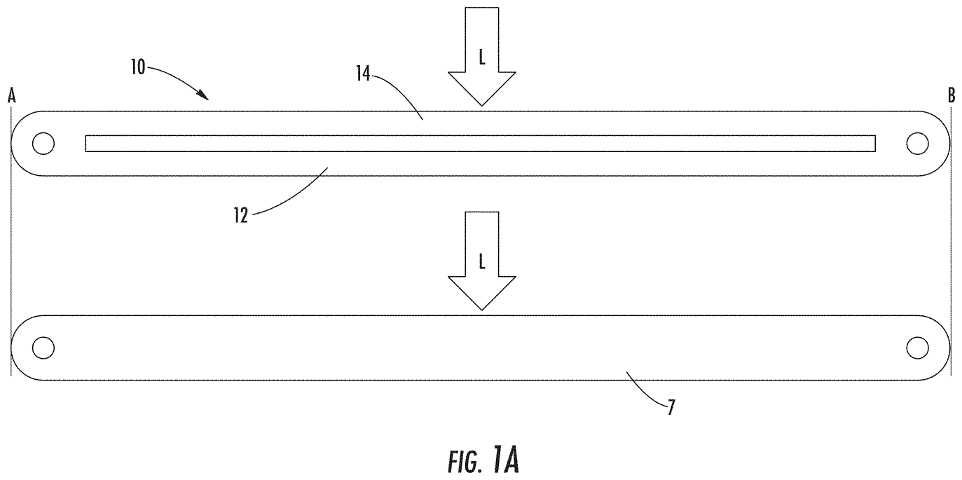

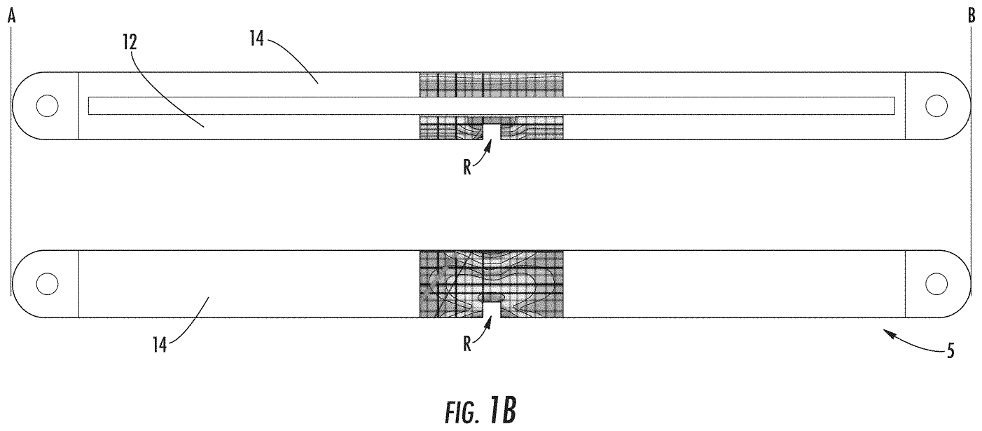

With reference to FIGS. 1A and 1B, a single load path structure 5 and a dual load path structure 10 made using additive manufacturing are shown. As used herein, the term “load path” refers to the direction in which a load will pass through connected members, or a pathway of maximum stress in a structure in response to an applied load. In FIG. 1A, the structures 5, 10 are shown prior to any load being applied, whereas in FIG. 1B a limit load has been applied to both structures and cracks have started forming in the structures as a result. In this regard, the limit load refers to the maximum load that the structure is expected to carry while in service. In contrast, an ultimate load refers to a load that is above the limit load and is typically not expected to occur, calculated as the limit load multiplied by a prescribed factor of safety. Thus in the context of aircraft structure and design, for example, the ultimate load is the amount of load applied to a component beyond which the component will fail.

Referring again to FIG. 1A, the single load path structure 5 includes a single load path 7, which may be thought of as a single element for bearing the applied limit load. The dual load path structure 10 includes two load paths 12, 14, which may be thought of as two elements for bearing the applied limit load.

As shown in FIG. 1B, both the single load path structure 5 and the dual load path structure 10, when subjected to a limit load L applied between ends A and B, experience critical failure in region R (e.g., the region where a first crack typically occurs), as the stress concentration in region R is above the maximum allowable stress.

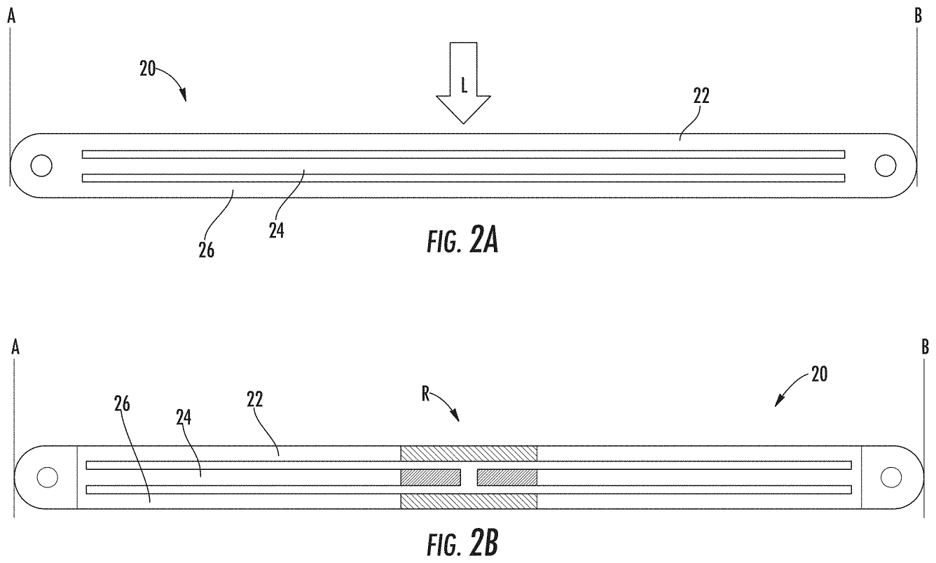

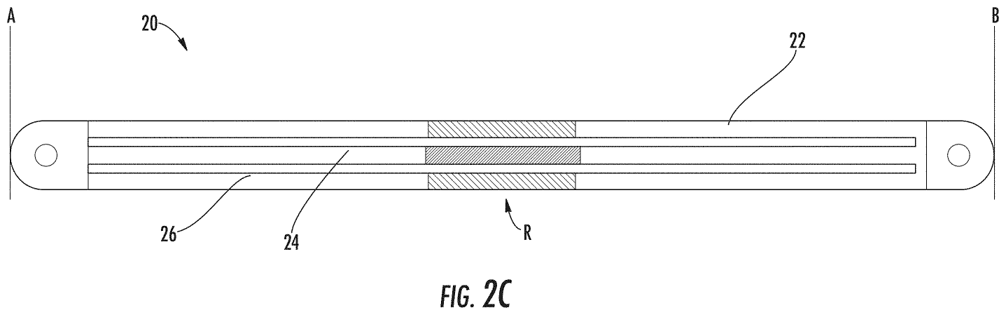

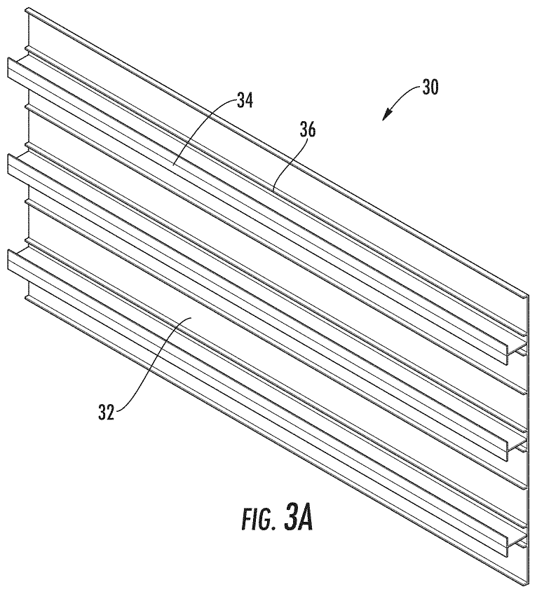

Turning now to FIG. 2A, embodiments of the present invention provide a structure 20 fabricated via additive manufacturing, where the structure includes a plurality of sub-structures 22, 24, 26 that are integrally formed via additive manufacturing. The sub-structures are configured to provide at least three load paths in an instance in which a load is applied to the structure. In FIG. 2A, for example, three sub-structures 22, 24, 26 are provided that are configured to provide three load paths in an instance in which a load L is applied to the structure, such as when a load is applied between ends A and B.

FIG. 2B illustrates that by providing a plurality of sub-structures 22, 24, 26 that provide at least three load paths (e.g., where each sub-structure represents a load path in the depicted example), the structure of FIG. 2A is capable of bearing the limit load and loads exceeding the limit load without experiencing critical failure, even when one of the substructures is damaged. In FIG. 2B, for example, when a limit load is applied between ends A and B, the three dimensional structure 20 does not experience critical failure. More specifically, although one of the sub-structures 24 may fail, the two other sub-structures 22, 26 are undamaged and are able to bear the limit load, experiencing a stress concentration in region R that is below the maximum allowable stress.

Indeed, turning to FIG. 2C, the structure 20 according to the embodiment depicted in FIGS. 2A and 2B is capable of carrying an ultimate load applied between ends A and B, with only one of the sub-structures 24 achieving a stress concentration in region R that is greater than the maximum allowable stress.

The structure 20 may be configured in various ways to take on different sizes and shapes, so as to be applicable in a number of design scenarios. As such, the sub-structures 22, 24, 26 may be made (via additive manufacturing) to have various configurations. In some embodiments, for example, adjacent sub-structures (e.g., sub-structures 22, 24 or 24, 26) may be separated by a material having different load-bearing properties than a material of the sub-structures, such as by a polymer. In still other embodiments, adjacent sub-structures 22, 24, 26 may be separated by an area of reduced stiffness, such as when the material has reduced thickness.

Accordingly, the sub-structures 22, 24, 26 may in some cases be thought of as strengthened portions of the structure (e.g., due to being made of a material with enhanced load-bearing characteristics with respect to the material forming the rest of the structure 20), while still being formed integrally with the structure 20 via additive manufacturing (e.g., in contrast with a sub-structure that may be formed separately and riveted, welded, adhered, or otherwise attached to a main body of the structure). By creating the structure 20 using additive manufacturing as a single-body component that integrally includes the sub-structures 22, 24, 26, rather than making a body and separately making sub-structures that are attached to the body to form the complete structure, structures that are lighter in weight and, at the same, stronger than counterpart structures having the same weight can be formed. The use of lightweight components is extremely important in certain industries such as in the aeronautics, aerospace, and automotive fields, as an example.

In addition to providing multiple load paths for bearing the applied load through the use of integral sub-structures 22, 24, 26, as described above, one or more of the sub-structures may also provide a mechanism to arrest the propagation of cracks through the structure 20, which would ultimately cause critical failure of the component. For example, while the applied load may cause cracks to propagate through the weaker material of the structure 20, those cracks may be stopped at stronger sub-structures 22, 24, 26. As such, the structure 20 of embodiments of the present invention may be configured such that at least one sub-structure is able to arrest propagation of a material failure of the structure resulting from the load.

In some embodiments, such as the embodiments depicted in FIGS. 2A-2C, adjacent sub-structures may be separated by an absence of material. In such embodiments, the absence of material may arrest the propagation of cracks from one sub-structure to the next. In some embodiments, for example, adjacent sub-structures 22, 24, 26 may be spaced apart by approximately half the thickness of the sub-structures. In either case, the structure is capable of continuing to support the limit load following failure of one of the sub-structures.

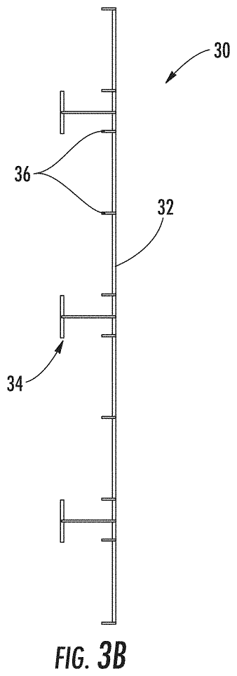

The structure 20 described above may be embodied in a number of forms, depending on the component being made and the application for which the component is designed. In some cases, for example, the structure is configured in the form of a panel 30, as shown in FIGS. 3A and 3B.

In some embodiments, the panel 30 may comprise a sheet 32 and two sub-structures 34, 36. The first sub-structure 34 may, for example, be an extended stringer, whereas the second sub-structure 36 may be a flange. In some embodiments, the first sub-structure 34 (e.g., the stringer) may extend substantially perpendicularly from a planar surface (e.g., the sheet 32) of the structure. As best illustrated in FIG. 3B, the stringer may have a T-shaped cross-section. In other embodiments, second sub-structure 36 (e.g., the flange) may extend substantially perpendicularly from a planar surface (e.g., the sheet 32) of the structure. In still other embodiments, as depicted in FIGS. 3A and 3B, both the first and the second sub-structures may extend substantially perpendicularly from a planar surface of the structure.

Notably, the sheet 32 and the sub-structures 34, 36 (e.g., the extended stringer and the flange in the depicted embodiment) are manufactured as a unitary panel via additive manufacturing, such that the sub-structures 34, 36 are formed integrally with the sheet 32, rather than being formed as discrete structures (e.g., separately formed flanges and/or extended stringers that are later riveted, welded, adhered, or otherwise affixed to the sheet). As such, in the depicted embodiment, the sheet 32 serves as a first load path; the first sub-structure 34 (e.g., the extended stringer) serves as a second load path; and the second sub-structure 36 (e.g., the flange) serves as the third load path. In the depicted embodiment, the three load paths are thus able to cooperatively bear the load that is applied to the panel 30 (e.g., the load applied to the panel during service), thereby increasing the panel's ultimate load capacity as compared to a conventional panel made via additive manufacturing that does not have three load paths or a conventional panel having riveted extended stringers, as examples.

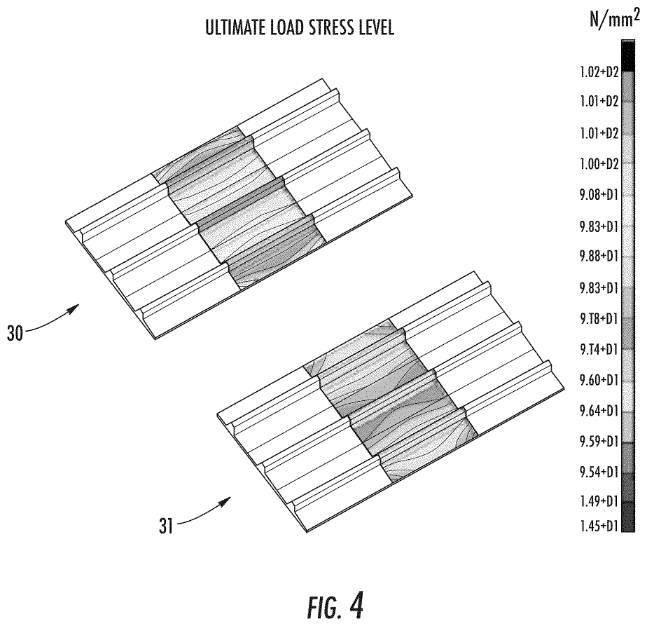

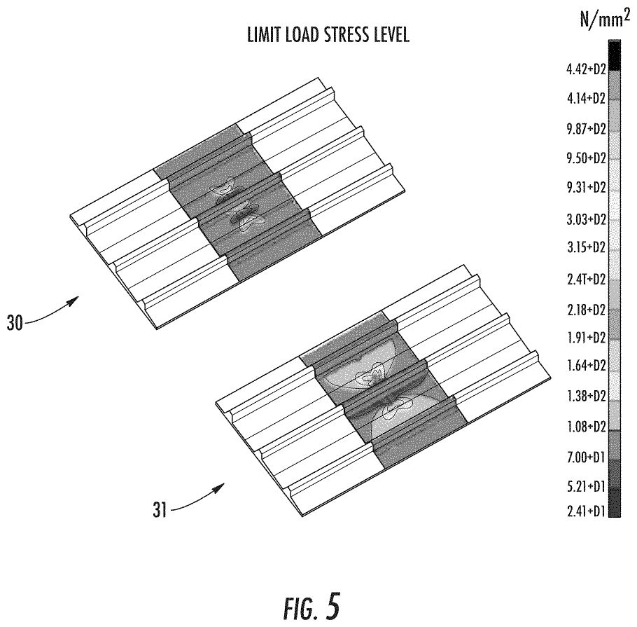

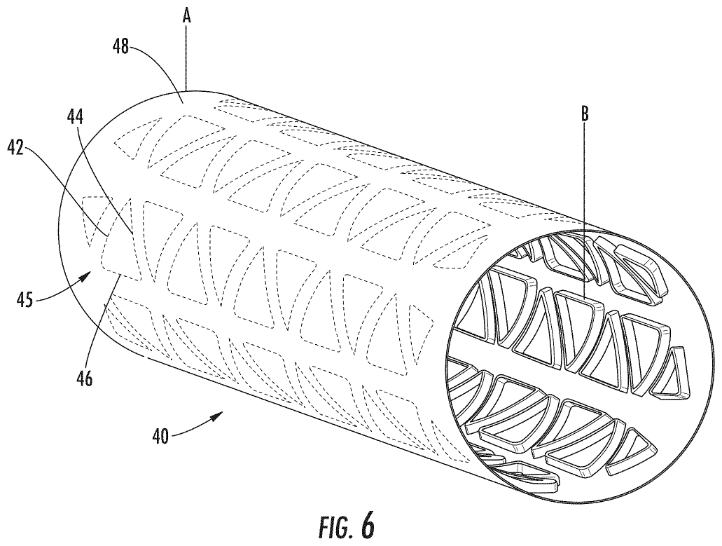

In addition to providing three load paths for bearing the load, the sub-structures 34, 36 may also serve to arrest the propagation of cracks and other failures between adjacent sections of the panel 30. With reference to FIG. 4, for example, the ultimate load capacity of a panel 30 made via additive manufacturing according to embodiments of the invention described herein is within the acceptable percentage with respect to the weight of the panel, whereas the ultimate load capacity of a standard panel 31 made via conventional methods (e.g., a forged panel including riveted extended stringers as shown) exceeds the acceptable percentage with respect to the weight of the panel. With reference to FIG. 5, for this same example, the limit load stress level of the panel 30 of the example embodiment is approximately 174 N/mm², whereas the limit load stress level of the standard panel 31 is approximately 295 N/mm², indicating that a more critical stress level has been attained. As depicted in FIG. 5, the standard panel 31 approaches critical failure of the panel in region R, near the junction of the riveted extended stringer to the sheet, whereas the panel 30 made via additive manufacturing according to embodiments of the invention described herein is still within acceptable stress concentrations.

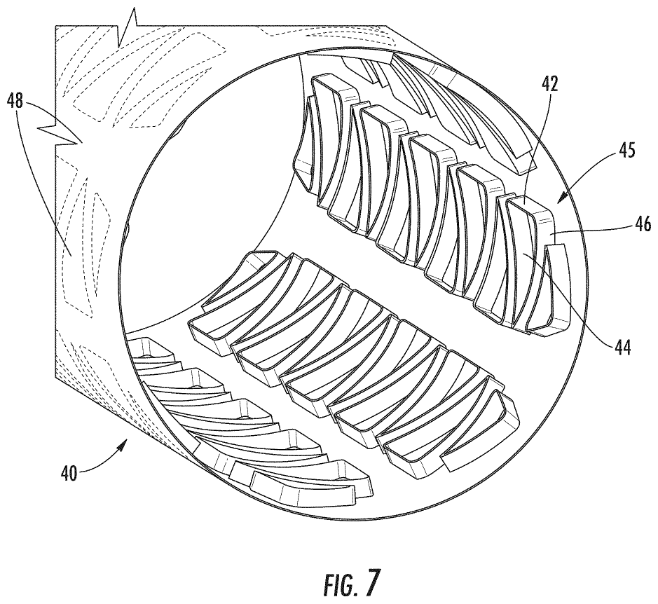

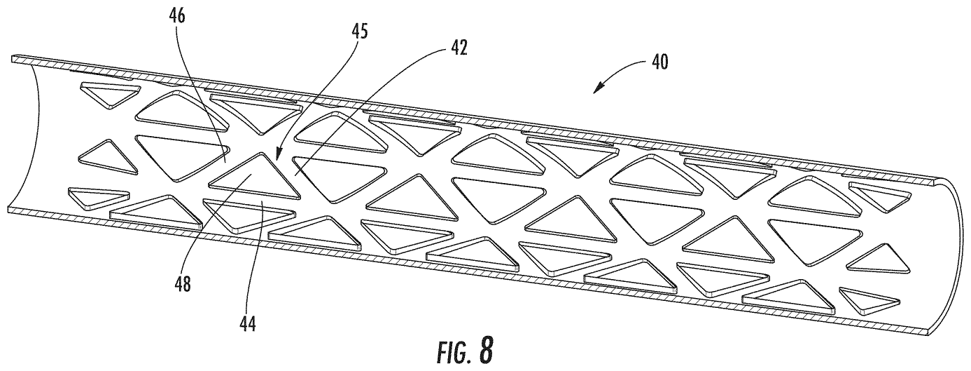

In still other embodiments, the structure is configured in the form of a tube 40, as shown in FIGS. 6-8. In such embodiments, each sub-structure 42, 44, 46 may comprise a region of increased thickness with respect to a thickness of the tube body 48, as best seen in FIGS. 7 and 8. Moreover, in some embodiments, the plurality of sub-structures 42, 44, 46 may form a plurality of triangular reinforcements 45. Although the example of sub-structures have a triangular shape is depicted and described herein, it is to be understood that other similar shapes may also be used, such as other polygonal shapes. For example, sets of three intersecting sub-structures 42, 44, 46 may form three sides of a triangular reinforcement 45, with the sides of the triangular reinforcement providing three load paths configured to bear a load applied between the ends A, B of the tube 40. In FIG. 7, the tube body 48 surrounds the sub-structures 42, 44, 46 and also forms the center of the triangular reinforcement 45. In other embodiments, however, such as shown in FIG. 8, the sub-structures 42, 44, 46 extend to the ends A, B of the tube 40, such that the tube body 40 having reduced thickness with respect to the sub-structures is located only between the triangular reinforcements 45.

In some embodiments, the sub-structures 42, 44, 46 may, as a result of increased thickness as noted above, due to use of a different material, or for other reasons, have an increased stiffness as compared to other areas of the tube 40. For this reason, the sub-structures 42, 44, 46 may attract and carry the load applied to the tube 40. In the event that one of the sub-structures 42, 44, 46 experiences critical failure (e.g., breaks), the load would be carried by the next stiffest portion of the tube 40, such as an adjacent sub-structure 42, 44, 46.

In addition, in some embodiments, the tube 40 may be configured such that a crack that forms in the tube body 48 would be arrested upon reaching one of the sub-structures 42, 44, 46. In this way, a crack would not be able to propagate through the tube 40 until a higher load is applied that causes failure of the sub-structures 42, 44, 46 themselves.

A method of manufacturing a structure using additive manufacturing is also provided herein. Such a method may include selectively providing a plurality of layers of material that combine to form a structure. As noted above, for example, the structure may be made by adding layer after layer of A material, such as plastic or metal, according to a certain configuration (e.g., in a certain size and/or shape), and these layers may be joined together to form a single, unitary component. 3D Printing, Rapid Prototyping (RP), and Direct Digital Manufacturing (DDM) are examples of ways in which a plurality of layers of material may be selectively provided and may combine to form the structure.

At least portions of the plurality of layers may integrally form a plurality of sub-structures of the structure, such as the sub-structures described above with respect to the embodiments depicted in FIGS. 2A-8. As described above, the plurality of sub-structures may be configured to provide at least three load paths in an instance in which a load is applied to the structure, thereby enabling the structure to bear a higher load before critical failure of the structure. For example, embodiments of the method may result in a structure that is capable of continuing to support a limit load following failure of one of the sub-structures. In some cases, at least one sub-structure may be configured to arrest propagation of a material failure of the structure resulting from the load.

In some embodiments, forming the structure may comprise varying a material of at least a portion of at least one of the plurality of layers such that adjacent sub-structures are separated by a material having different load-bearing properties than a material of the sub-structures. For example, forming the structure may comprise selectively providing the plurality of layers of material such that each sub-structure comprises a region of increased thickness, as shown in the embodiments depicted in FIGS. 6-8 described above. In other cases, forming the structure may comprise selectively providing the plurality of layers of material such that adjacent sub-structures are separated by an absence of material, as shown in the embodiments depicted in FIGS. 2A and 2B.

In still other embodiments, the method may be used to form a structure that is a panel, as shown in FIGS. 3-5. In such embodiments, forming the structure may comprise selectively providing the plurality of layers of material such that at least one sub-structure comprises a stringer extending substantially perpendicularly from a planar surface of the structure. Forming the structure may likewise comprise selectively providing the plurality of layers of material such that at least one of the sub-structures comprises a flange extending substantially perpendicularly from a planar surface of the structure.

In still other embodiments, the method used to form a structure may comprise selectively providing the plurality of layers of material such that the structure is a tube, as shown in FIGS. 6-8. Forming the structure may thus comprise selectively providing the plurality of layers of material such that the plurality of sub-structures form a plurality of triangular reinforcements, as described above. In such ways, the method as described above may be used to manufacture a structure that can serve as a component of an aircraft, for example. Because embodiments of the method result in a structure that is integrally-formed with three built-in load paths, the resulting components may retain the advantages of additive manufacturing (e.g., they may be light-weight and easy to make in relatively complicated configurations), but at the same time may have increased load-bearing characteristics relative to their weight, thereby increasing their service life and minimizing the risk of the component experiencing catastrophic failure in service.

Many modifications and other embodiments of the disclosure set forth herein will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed is:

1. A structure fabricated via additive manufacturing, wherein the structure comprises a plurality of sub-structures integrally formed via additive manufacturing,
wherein the plurality of sub-structures is configured to provide the structure with at least three load paths in an instance in which a load is applied to the structure, and
wherein the structure is capable of continuing to support the load following failure of one of the sub-structures.

2. The structure of claim 1, wherein at least one sub-structure is configured to arrest propagation of a material failure of the structure resulting from the load.

3. The structure of claim 1, wherein adjacent sub-structures are separated by a material having different load-bearing properties than a material of the sub-structures.

4. The structure of claim 1, wherein adjacent sub-structures are separated by an absence of material.

5. The structure of claim 1, wherein at least one of the sub-structures comprises a region of increased thickness.

6. The structure of claim 1, wherein adjacent sub-structures are separated by an area of reduced stiffness.

7. The structure of claim 1, wherein the structure is a panel.

8. The structure of claim 7, wherein at least one of the sub-structures comprises a stringer extending substantially perpendicularly from a planar surface of the structure.

9. The structure of claim 7, wherein at least one of the sub-structures comprises a flange extending substantially perpendicularly from a planar surface of the structure.

10. The structure of claim 1, wherein the structure is a tube.

11. The structure of claim 10, wherein the plurality of sub-structures form a plurality of triangular reinforcements.

12. A method of manufacturing a structure using additive manufacturing, wherein the method comprises:
selectively providing a plurality of layers of material that combine to form a structure,
wherein at least portions of the plurality of layers integrally form a plurality of sub-structures of the structure, and
wherein the plurality of sub-structures is configured to provide the structure with at least three load paths in an instance in which a load is applied to the structure.

13. The method of claim 12, wherein at least one sub-structure is configured to arrest propagation of a material failure of the structure resulting from the load.

14. The method of claim 12, wherein the structure is capable of continuing to support the load following failure of one of the sub-structures.

15. The method of claim 12, wherein forming the structure comprises varying a material of at least a portion of at least one of the plurality of layers such that adjacent sub-structures are separated by a material having different load-bearing properties than a material of the sub-structures.

16. The method of claim 12, wherein forming the structure comprises selectively providing the plurality of layers of material such that adjacent sub-structures are separated by an absence of material.

17. The method of claim 12, wherein forming the structure comprises selectively providing the plurality of layers of material such that each sub-structure comprises a region of increased thickness.

18. The method of claim 12, wherein the structure is a panel, and wherein forming the structure comprises selectively providing the plurality of layers of material such that at least one sub-structure comprises a stringer extending substantially perpendicularly from a planar surface of the structure.

19. The method of claim 12, wherein the structure is a panel, and wherein forming the structure comprises selectively providing the plurality of layers of material such that at least one of the sub-structures comprises a flange extending substantially perpendicularly from a planar surface of the structure.

20. The method of claim 12, wherein forming the structure comprises selectively providing the plurality of layers of material such that the structure is a tube, and wherein forming the structure comprises selectively providing the plurality of layers of material such that the plurality of sub-structures form a plurality of triangular reinforcements.
